(19) United States
(12) Patent Application Publication
(10) Pub. No.: US 2026/0177260 A1
(43) Pub. Date: Jun. 25, 2026

(54) OWNER AUTHENTICATION SYSTEM

(71) Applicant: Mitsubishi Electric Corporation, Tokyo (JP)

(72) Inventors: Yuki WAKAI, Tokyo (JP); Masatoshi ITO, Tokyo (JP); Takumi ISEYA, Tokyo (JP)

(21) Appl. No.: 19/123,950

(22) PCT Filed: Jan. 24, 2023
(86) PCT No.: PCT/JP2023/002055

§ 371 Date: Apr. 24, 2025

(51) Int. Cl. F24F 11/30; H04L 9/40

(52) U.S. Cl. CPC F24F 11/30; H04L 63/08

(57) ABSTRACT

An owner authentication system includes a facility device, a data management server, and a user terminal. The facility device includes an operation data retention unit that retains operation data, a first information provision unit that transmits, to the data management server, device association data in which first operation data in the operation data is associated with device identification information, and a second information provision unit that transmits, to a user terminal, second operation data in the operation data. The user terminal requests the data management server to perform authentication of whether the user terminal is a terminal corresponding to an owner of the facility device by transmitting, to the data management server, user association data in which the second operation data is associated with user identification information. The data management server performs the authentication by comparing the first operation data with the second operation data.

### CROSS-REFERENCE TO RELATED APPLICATION

This application is a U.S. national stage application of PCT/JP2023/002055 filed on Jan. 24, 2023, the contents of which are incorporated herein by reference.

### FIELD

The present disclosure relates to an owner authentication system and an owner authentication method for authenticating an owner of a facility device.

### BACKGROUND

An owner authentication system for authenticating an owner of a facility device such as an air conditioner is applied to, for example, a control system, etc. in which an air conditioner is remotely controlled by a user terminal such as a smartphone. In the control system, a data management server permits the user terminal to remotely control the facility device only when the data server can authenticate a user on the basis of identification information sent from the user terminal.

In a communication system disclosed in Patent Literature 1, a management device acquires, via each of two different paths, identification information on a relaying apparatus that communicates with a residential facility device, and verifies a communication terminal of a user on the basis of each identification information. The management device verifies the communication terminal of the user on the basis of whether the identification information received from the relaying apparatus via a wireless Local Area Network (LAN) router matches the identification information received from the relaying apparatus via the communication terminal of the user.

### PATENT LITERATURE

Patent Literature 1: Japanese Patent Application Laid-open No. 2018-182452

Unfortunately, a problem with the technique of Patent Literature 1 is that when the communication terminal of a user who is a past owner of the residential facility device and replaced with another user for reasons such as a move transmits the past acquired identification information to the management device, the management device mistakes the user who is the past owner for a current owner of the residential facility device.

### SUMMARY

The present disclosure has been made in view of the above circumstances, and an object of the present disclosure is to provide an owner authentication system capable of correctly recognizing a current owner of a facility device.

In order to solve the above-described problem and achieve the object, an owner authentication system of the present disclosure comprises: a facility device; a data management server connected to the facility device; and a user terminal connectable to the facility device and the data management server. The facility device includes: a device identification information retention unit to retain device identification information that is identification information on the facility device; and an operation data retention unit to retain operation data that is dynamic data varying over time in the facility device. The facility device further includes: a first information provision unit to transmit, to the data management server, device association data in which first operation data in the operation data is associated with the device identification information; and a second information provision unit to transmit, to the user terminal, second operation data in the operation data. The user terminal includes: a user identification information retention unit to retain user identification information that is identification information on the user terminal; and an authentication request unit to request the data management server to perform authentication of whether the user terminal is a terminal corresponding to an owner of the facility device, by transmitting, to the data management server, user association data in which the second operation data is associated with the user identification information. The data management server includes a matching verification unit to perform the authentication by comparing the first operation data included in the device association data with the second operation data included in the user association data.

The owner authentication system according to the present disclosure has an effect of correctly recognizing the current owner of the facility device.

### BRIEF DESCRIPTION OF DRAWINGS

FIG. 1 is a diagram illustrating a schematic configuration of an owner authentication system according to an embodiment.

FIG. 2 is a flowchart illustrating a processing procedure of first processing performed by the owner authentication system according to the embodiment.

FIG. 3 is a diagram for describing device identification information retained in a device identification information retention unit of the owner authentication system according to the embodiment.

FIG. 4 is a flowchart illustrating a processing procedure of second processing performed by the owner authentication system according to the embodiment.

FIG. 5 is a diagram for describing user identification information retained in a user identification information retention unit of the owner authentication system according to the embodiment.

FIG. 6 is a diagram illustrating exemplary configurations of pieces of air-conditioning operation data to be used for owner determination in the owner authentication system according to the embodiment.

FIG. 7 is a diagram for describing processing of determining whether variation values of pieces of air-conditioning operation data match each other, the processing being performed by the owner authentication system according to the embodiment.

FIG. 8 is a diagram illustrating an exemplary configuration of correspondence information in which device identification information is associated with user identification information, the correspondence information being created by the owner authentication system according to the embodiment.

FIG. 9 is a diagram illustrating an exemplary configuration of processing circuitry in a case where a processor and a memory implement the processing circuitry included in a data management server according to the embodiment.

FIG. 10 is a diagram illustrating an example of processing circuitry in a case where dedicated hardware implements the processing circuitry included in the data management server according to the embodiment.

### DETAILED DESCRIPTION

Hereinafter, with reference to the drawings, a description will be given in detail of an owner authentication system and an owner authentication method according to an embodiment of the present disclosure.

### Embodiment

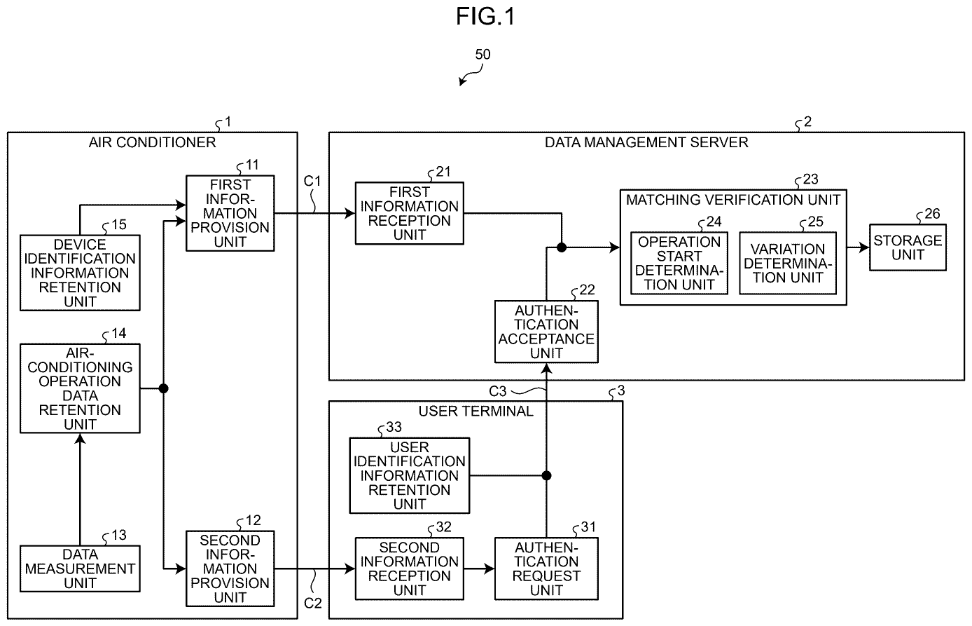

FIG. 1 is a diagram illustrating a schematic configuration of an owner authentication system according to an embodiment. An owner authentication system (air conditioner management system) 50 includes an air conditioner 1, a data management server 2, and a user terminal 3. The air conditioner 1 is an example of a facility device. The data management server 2 is a data management device. The owner authentication system 50 is a system that authenticates (confirms the identity of) an owner of the air conditioner 1.

The data management server 2 determines whether an owner (user) who operates the user terminal 3 is the owner of the air conditioner 1, on the basis of whether information sent from the user terminal 3 matches information sent from the air conditioner 1. Examples of the user terminal 3 include a smartphone, a tablet terminal, and the like.

The air conditioner 1 includes a first information provision unit 11, a second information provision unit 12, a data measurement unit 13, an air-conditioning operation data retention unit (operation data retention unit) 14, and a device identification information retention unit 15. The data management server 2 includes a first information reception unit 21, an authentication acceptance unit 22, a matching verification unit 23, and a storage unit 26. The matching verification unit 23 includes an operation start determination unit 24 and a variation determination unit 25. The user terminal 3 includes an authentication request unit 31, a second information reception unit 32, and a user identification information retention unit 33.

The air conditioner 1 is connected to the data management server 2. Additionally, the user terminal 3 is connectable to the air conditioner 1 and the data management server 2. FIG. 1 illustrates the user terminal 3 being connected to the air conditioner 1 and the data management server 2.

The air conditioner 1 transmits and receives data to and from the data management server 2 via a first network communication path C1. The air conditioner 1 transmits and receives data to and from the user terminal 3 via a second network communication path C2. The data management server 2 transmits and receives data to and from the user terminal 3 via a third network communication path C3.

The data measurement unit 13 measures variation data. The variation data, which is data varying in the air conditioner 1, is defined as air-conditioning operation data (operation data on a facility device). The air-conditioning operation data is dynamic data varying over time. Data which the data measurement unit 13 measures as the air-conditioning operation data is, for example, room temperature variation data, operation start data, and collection time data. The room temperature variation data indicates a variation in a room temperature. The operation start data indicates the start and end of an air-conditioning operation. The collection time data indicates the time at which the room temperature has been measured. The room temperature variation data is data indicating a variation in a room temperature of a room in which an indoor unit of the air conditioner 1 is disposed. The data measurement unit 13 may acquire the air-conditioning operation data, using a sensor, etc. or from a control device (not illustrated), etc. of the air conditioner 1.

The operation start data is, for example, data indicating whether an air-conditioning operation power supply of the air conditioner 1 is in an ON state or an OFF state. Since the operation start data is data indicating the start and end of the air-conditioning operation, it can be determined, from the continuously measured pieces of operation start data, whether the air-conditioning is in or out of operation. The data measurement unit 13 sends the measured pieces of air-conditioning operation data to the air-conditioning operation data retention unit 14.

The air-conditioning operation data retention unit 14 retains air-conditioning operation data in which the room temperature variation data, the operation start data, and the collection time data are associated with each other. The device identification information retention unit 15 retains device identification information that is information for identifying the air conditioner 1.

The first information provision unit 11 reads the device identification information from the device identification information retention unit 15 and reads the air-conditioning operation data from the air-conditioning operation data retention unit 14. The first information provision unit 11 transmits data (hereinafter referred to as device association data where necessary) to the data management server 2 via the first network communication path C1. The device association data is data in which the device identification information is associated with the air-conditioning operation data.

The second information provision unit 12 reads the air-conditioning operation data from the air-conditioning operation data retention unit 14. The second information provision unit 12 transmits the air-conditioning operation data to the user terminal 3 via the second network communication path C2.

The second information reception unit 32 of the user terminal 3 receives the air-conditioning operation data from the air conditioner 1. The second information reception unit 32 sends the received air-conditioning operation data to the authentication request unit 31. The user identification information retention unit 33 retains user identification information for identifying the user who is the owner of the user terminal 3.

The authentication request unit 31 reads the user identification information from the user identification information retention unit 33. By transmitting, to the data management server 2, data (hereinafter referred to as user association data where necessary), the authentication request unit 31 requests the data management server 2 to authenticate the user (to authenticate the user as the owner of the air conditioner 1). The user association data is data in which the user identification information is associated with the air-conditioning operation data.

The first information reception unit 21 of the data management server 2 receives, from the air conditioner 1, the device association data in which the device identification information is associated with the air-conditioning operation data. The first information reception unit 21 sends the received device association data to the matching verification unit 23.

The authentication acceptance unit 22 receives, from the user terminal 3, the user association data in which the user identification information is associated with the air-conditioning operation data. The authentication acceptance unit 22 sends the received user association data to the matching verification unit 23.

The matching verification unit 23 authenticates the air-conditioning operation data on the basis of the device association data and the user association data. The matching verification unit 23 compares the air-conditioning operation data included in the device association data with the air-conditioning operation data included in the user association data to thereby verify whether these two pieces of air-conditioning operation data match each other.

The operation start determination unit 24 of the matching verification unit 23 receives the device association data sent from the first information reception unit 21. The operation start determination unit 24 also receives the user association data sent from the authentication acceptance unit 22.

The operation start determination unit 24 determines, on the basis of the device association data or the user association data, a specific period from the start of operation of the air conditioner 1. Such a specific period may be hereinafter referred to as an operation start period. The operation start period is a specific period (e.g., 15 minutes) immediately after the start of a test operation of the air-conditioning. The operation start determination unit 24 sets the operation start period as the specific period immediately after the start of the test operation of the air-conditioning, because the air-conditioning operation data varies greatly within the specific period immediately after the start of the test operation of the air-conditioning. The operation start determination unit 24 sends the set operation start period to the variation determination unit 25.

The variation determination unit 25 determines whether the variation (feature) of the air-conditioning operation data received from the air conditioner 1 matches the variation (feature) of the air-conditioning operation data received from the user terminal 3. Specifically, the variation determination unit 25 determines whether the room temperature variation data in the device association data matches the room temperature variation data in the user association data, within the range of the operation start period. That is, the variation determination unit 25 determines whether the room temperature variation data received from the air conditioner 1 within the range of the operation start period matches the room temperature variation data received from the user terminal 3 within the range of the operation start period.

The variation determination unit 25 determines that the owner of the user terminal 3 is the owner of the air conditioner 1 when the room temperature variation data in the device association data matches the room temperature variation data in the user association data, within the operation start period. On the other hand, the variation determination unit 25 determines that the owner of the user terminal 3 is not the owner of the air conditioner 1 when the room temperature variation data in the device association data does not match the room temperature variation data in the user association data, within the range of the operation start period.

When determining that the owner of the user terminal 3 is the owner of the air conditioner 1, the variation determination unit 25 sends, to the storage unit 26, the device identification information included in the device association data and the user identification information included in the user association data, the device identification information and the user identification information being associated with each other. That is, when the room temperature variation data in the device association data matches the room temperature variation data in the user association data, within the range of the operation start period, the variation determination unit 25 sends, to the storage unit 26, the device identification information and the user identification information in association with each other. The processing of associating the device identification information with the user identification information by the variation determination unit 25 corresponds to the processing of authenticating the user terminal 3 corresponding to the user identification information. The storage unit 26 stores the device identification information and the user identification information in association with each other.

As described above, since the air-conditioning operation data immediately after the start of the operation characteristically has a large variation and a large information amount, the owner authentication system 50 determines the owner, using the air-conditioning operation data in the operation start period. Additionally, since the air-conditioning operation data in the operation start period includes data (e.g., air-conditioning operation data) which the current owner alone can know, the owner authentication system 50 can authenticate the owner of the air conditioner 1, using the air-conditioning operation data in a short period and can authenticate the owner in a short period without requiring the user to wait.

Note that in the following description, the air-conditioning operation data included in the device association data may be referred to as first air-conditioning operation data (first operation data), and the air-conditioning operation data included in the user association data may be referred to as second air-conditioning operation data (second operation data).

In response to an authentication request of the user terminal 3, the air conditioner 1 transmits the first air-conditioning operation data to the data management server 2 and transmits the second air-conditioning operation data to the user terminal 3. The air conditioner 1 transmits, for example in real time, the acquired air-conditioning operation data to the user terminal 3 and the data management server 2. That is, in response to an authentication request of the user terminal 3, the air conditioner 1 transmits the acquired air-conditioning operation data to the user terminal 3 and the data management server 2 each time the air-conditioning operation data is acquired (e.g., every minute).

Note that in response to an authentication request of the user terminal 3, the air conditioner 1 may transmit, by batch, the acquired pieces of air-conditioning operation data to the user terminal 3 and the data management server 2. For example, in response to an authentication request of the user terminal 3, the air conditioner 1 may transmit, by batch, the pieces of air-conditioning operation data acquired for 20 minutes, to the user terminal 3 and the data management server 2.

Next, a description will be given of an operation of the owner authentication system 50 (a procedure of processing performed by the owner authentication system 50). First, a description will be given of processing (first processing) when the data management server 2 receives, from the air conditioner 1, and stores the first air-conditioning operation data (room temperature variation data, operation start data, and collection time data). Then, a description will be given of processing (second processing) when the data management server 2 authenticates the user terminal 3 for the air conditioner 1.

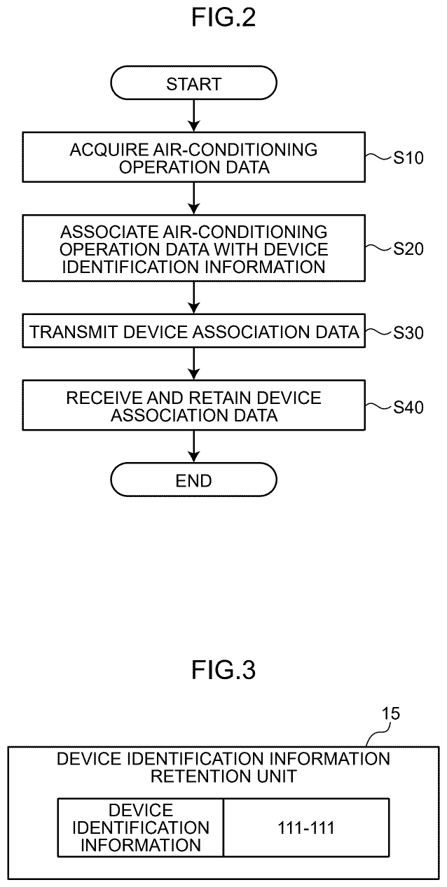

FIG. 2 is a flowchart illustrating a processing procedure of the first processing performed by the owner authentication system according to the embodiment. The air conditioner 1 starts a test operation in accordance with an instruction from a user who owns the air conditioner 1. The data measurement unit 13 acquires the air-conditioning operation data by measuring the air-conditioning operation data at the time of start of the test operation (step S10). The data measurement unit 13 measures, as the air-conditioning operation data, the room temperature variation data, the operation start data indicating the start and end of the air-conditioning operation, and the collection time data. The data measurement unit 13 sends the measured air-conditioning operation data to the air-conditioning operation data retention unit 14. The air-conditioning operation data retention unit 14 retains the air-conditioning operation data. The air conditioner 1 continues to collect the air-conditioning operation data, for example, irrespective of whether the air-conditioning operation power supply is in an OFF state or an ON state. Note that the air conditioner 1 may collect the air-conditioning operation data only, for example, when the air-conditioning operation power supply is in the ON state.

The first information provision unit 11 associates the first air-conditioning operation data retained in the air-conditioning operation data retention unit 14 with the device identification information retained in the device identification information retention unit 15 (step S20).

FIG. 3 is a diagram for describing the device identification information retained in the device identification information retention unit of the owner authentication system according to the embodiment. In the owner authentication system 50, the device identification information retention unit 15 retains the device identification information for identifying the air conditioner 1.

The first information provision unit 11 transmits, to the data management server 2 via the first network communication path C1, the device association data in which the device identification information is associated with the air-conditioning operation data (first air-conditioning operation data) (step S30).

The data management server 2 receives and retains the device association data sent from the first information provision unit 11 (step S40). Specifically, the first information reception unit 21 of the data management server 2 receives the device association data, and the operation start determination unit 24 retains the device association data. Note that the data management server 2 may store the device association data in the storage unit 26 or in another storage unit (not illustrated).

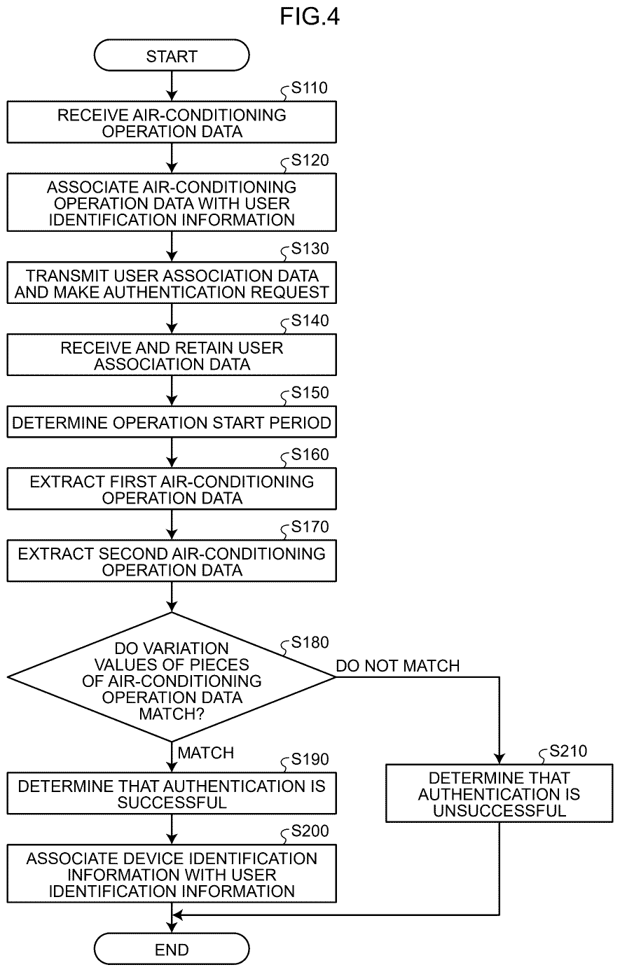

FIG. 4 is a flowchart illustrating a processing procedure of the second processing performed by the owner authentication system according to the embodiment. The user terminal 3 receives the air-conditioning operation data from the air conditioner 1 (step S110). Specifically, the second information reception unit 32 of the user terminal 3 receives, from the second information provision unit 12 via the second network communication path C2, the air-conditioning operation data (room temperature variation data, operation start data, and collection time data) retained in the air-conditioning operation data retention unit 14 of the air conditioner 1.

The authentication request unit 31 associates the second air-conditioning operation data received from the air conditioner 1 with the user identification information retained in the user identification information retention unit 33 (step S120).

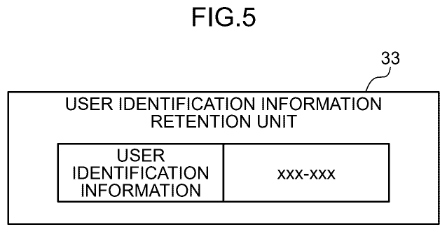

FIG. 5 is a diagram for describing the user identification information retained in the user identification information retention unit of the owner authentication system according to the embodiment. In the owner authentication system 50, the user identification information retention unit 33 retains the user identification information for identifying the user (user terminal 3).

The authentication request unit 31 associates the user identification information with the air-conditioning operation data (second air-conditioning operation data) received from the air conditioner 1. The authentication request unit 31 of the user terminal 3 transmits, to the data management server 2, the user association data in which the user identification information is associated with the second air-conditioning operation data, and the authentication request as well in order to request the data management server 2 to authenticate the user terminal 3 as the owner of the air conditioner 1. Note that the user association data itself may be the authentication request. In this case, the data management server 2 determines, upon receiving the user association data, that the authentication request has also been received. The authentication request unit 31 transmits the user association data including the authentication request to the data management server 2 via the third network communication path C3. In this manner, the authentication request unit 31 transmits the user association data and makes the authentication request (step S130).

The data management server 2 receives, from the user terminal 3, and retains the user association data in which the user identification information is associated with the air-conditioning operation data (step S140). Specifically, the authentication acceptance unit 22 of the data management server 2 receives the user association data, and the operation start determination unit 24 retains the user association data. Note that the data management server 2 may store the user association data in the storage unit 26 or in another storage unit (not illustrated).

The operation start determination unit 24 of the data management server 2 determines the operation start period on the basis of the air-conditioning operation data in the device association data (step S150). Note that the operation start determination unit 24 may determine the operation start period on the basis of the air-conditioning operation data in the user association data.

The operation start determination unit 24 of the data management server 2 extracts, from the first air-conditioning operation data, the first air-conditioning operation data in the operation start period obtained in the processing of step S150 (step S160).

Additionally, the operation start determination unit 24 extracts, from the second air-conditioning operation data, the second air-conditioning operation data in the operation start period obtained in the processing of step S150 (step S170).

The variation determination unit 25 determines whether variation values of the pieces of air-conditioning operation data, which are the pieces of extracted data, match each other (step S180). That is, the variation determination unit 25 determines whether the variation value of the room temperature variation data included in the first air-conditioning operation data extracted in step S160 matches the variation value of the room temperature variation data included in the second air-conditioning operation data extracted in step S170.

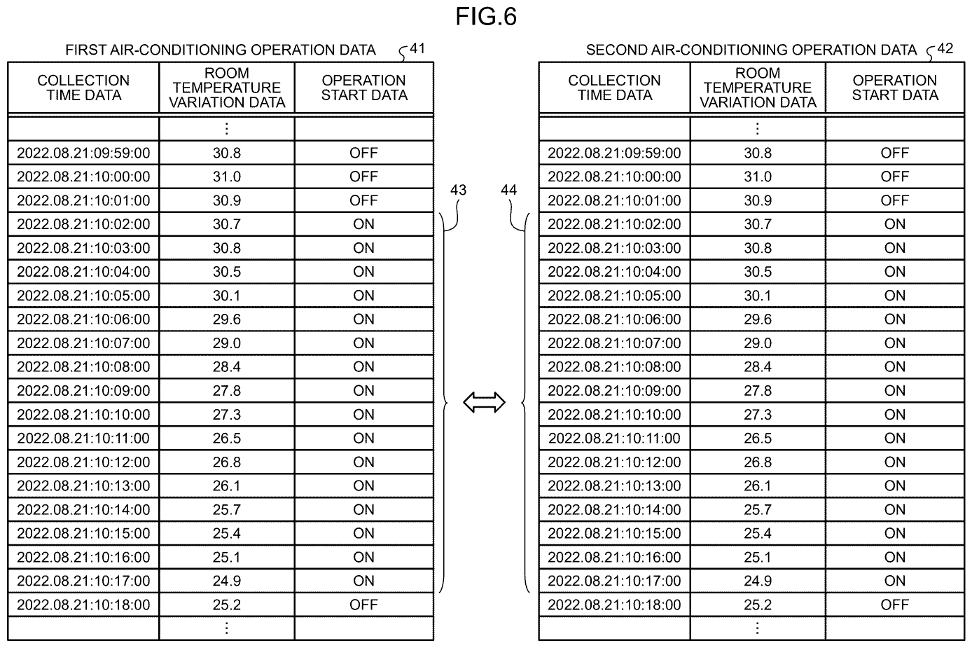

A description will be given of the configurations of the pieces of air-conditioning operation data to be compared by the variation determination unit 25. FIG. 6 is a diagram illustrating exemplary configurations of pieces of air-conditioning operation data to be used for owner determination in the owner authentication system according to the embodiment.

The air-conditioning operation data illustrated on the left side of FIG. 6 is an exemplary configuration of first air-conditioning operation data 41, and the air-conditioning operation data illustrated on the right side of FIG. 6 is an exemplary configuration of second air-conditioning operation data 42. FIG. 6 illustrates examples of the first air-conditioning operation data 41 and the second air-conditioning operation data 42 when the air-conditioning operation power supply is changed from an OFF state to an ON state and subsequently to the OFF state after a lapse of 15 minutes therefrom. Note that the period during which the air-conditioning operation power supply is in the ON state is not limited to 15 minutes and may be any period longer than or equal to the operation start period.

In each of the first air-conditioning operation data 41 and the second air-conditioning operation data 42, collection time data, room temperature variation data, and operation start data are associated with each other. The collection time data is a point of time at which air-conditioning operation data is collected.

The first air-conditioning operation data 41 is the air-conditioning operation data stored in the device association data, and the second air-conditioning operation data 42 is the air-conditioning operation data stored in the user association data.

The first air-conditioning operation data 41 includes first air-conditioning operation data 43 that is air-conditioning operation data in the period during which the air-conditioning operation power supply is in the ON state. The second air-conditioning operation data 42 includes second air-conditioning operation data 44 that is air-conditioning operation data in the period during which the air-conditioning operation power supply is in the ON state. That is, an example of the first air-conditioning operation data extracted from the first air-conditioning operation data 41 by the operation start determination unit 24 is the first air-conditioning operation data 43. Additionally, an example of the second air-conditioning operation data extracted from the second air-conditioning operation data 42 by the operation start determination unit 24 is the second air-conditioning operation data 44. The variation determination unit 25 compares the first air-conditioning operation data 43 with the second air-conditioning operation data 44. When the owner of the user terminal 3 is identical to the owner of the air conditioner 1, the first air-conditioning operation data 43 is the same as the second air-conditioning operation data 44.

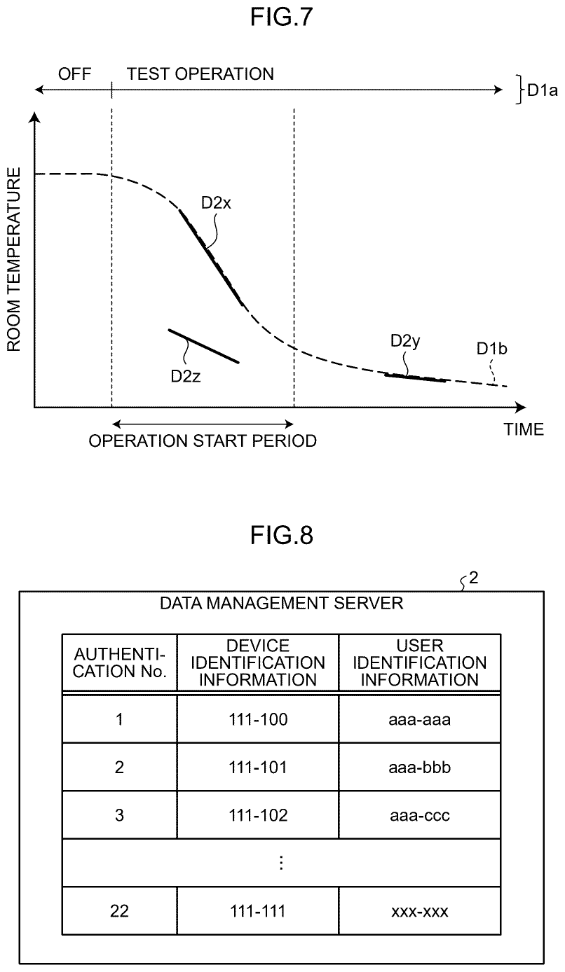

A description will be given of processing of determining whether the variation values of the pieces of air-conditioning operation data match each other. FIG. 7 is a diagram for describing processing of determining whether the variation values of the pieces of air-conditioning operation data match each other, the processing being performed by the owner authentication system according to the embodiment. In the graph illustrated in FIG. 7, the vertical axis represents a room temperature, and the horizontal axis represents time. FIG. 7 illustrates a room temperature varying over time.

The data management server 2 acquires the device association data via the first path that is the first network communication path C1. The air-conditioning operation data in the device association data includes operation start data D1a and room temperature variation data D1b. The operation start data D1a is data indicating whether the air-conditioning operation power supply is in an ON state or an OFF state. Thus, the variation determination unit 25 can determine, on the basis of the operation start data D1a, whether the air conditioner 1 is performing a test operation or the air-conditioning operation power supply is in the OFF state. Additionally, the variation determination unit 25 can determine, on the basis of the room temperature variation data D1b, the transition (variation value) of the room temperature over time.

The operation start determination unit 24 of the data management server 2 determines the operation start period on the basis of the operation start data D1a. The operation start determination unit 24 determines, as the operation start period, a specific period from the time the air-conditioning operation power supply is changed from the OFF state to the ON state.

Additionally, the data management server 2 acquires the user association data via the second path including the second network communication path C2 and the third network communication path C3.

The air-conditioning operation data in the user association data includes the room temperature variation data. FIG. 7 illustrates room temperature variation data D2x, D2y, and D2z as an example of the room temperature variation data included in the air-conditioning operation data in the user association data. The room temperature variation data D2x is a first pattern (first example) of the room temperature variation data, the room temperature variation data D2y is a second pattern (second example) of the room temperature variation data, and the room temperature variation data D2z is a third pattern (third example) of the room temperature variation data.

Since the room temperature variation data D2y, which is the second pattern of the room temperature variation data, is the room temperature variation data outside the operation start period, the variation determination unit 25 does not admit that the user terminal 3 having sent the user association data is the owner of the air conditioner 1.

Since the variation value of the room temperature variation data D2z, which is the third pattern of the room temperature variation data, does not match the variation value of the room temperature variation data D1b of the device association data, the variation determination unit 25 does not admit that the user terminal 3 having sent the user association data is the owner of the air conditioner 1.

The room temperature variation data D2x, which is the first pattern of the room temperature variation data, is the room temperature variation data within the operation start period. Additionally, the variation value of the room temperature variation data D2x matches the variation value of the room temperature variation data D1b of the device association data. In this case, the variation determination unit 25 admits that the user terminal 3 having sent the user association data is the owner of the air conditioner 1. As described above, since the variation value of the room temperature variation data D2x within the operation start period matches the variation value of the room temperature variation data D1b, the variation determination unit 25 admits that the user terminal 3 having sent the user association data including the room temperature variation data D2x is the owner of the air conditioner 1.

When determining that the variation values of the pieces of air-conditioning operation data match each other (step S180, match), the variation determination unit 25 determines that the authentication of the user terminal 3 is successful (step S190). Then, the variation determination unit 25 associates the device identification information with the user identification information (step S200). That is, when the variation values of the pieces of room temperature variation data within the operation start period match each other, the variation determination unit 25 authenticates the owner (user) of the user terminal 3 having sent the user identification information, as the owner (user) of the air conditioner 1, and associates the device identification information with the user identification information. In this way, the variation determination unit 25 ends the processing of authenticating the user terminal 3.

On the other hand, when determining that the variation values of the pieces of air-conditioning operation data do not match each other (step S180, do not match), the variation determination unit 25 determines that the authentication of the user terminal 3 is unsuccessful (step S210). That is, the variation determination unit 25 determines that the owner (user) of the user terminal 3 having sent the user identification information is not the owner (user) of the air conditioner 1. Then, the variation determination unit 25 ends the processing of authenticating the user terminal 3.

As described above, when the variation determination unit 25 of the data management server 2 authenticates the owner of the user terminal 3 having sent the user identification information, as the owner of the air conditioner 1, the variation determination unit 25 creates correspondence information in which the device identification information is associated with the user identification information. This correspondence information is stored in the storage unit (e.g., storage unit 26) within the data management server 2. The data management server 2 retains the correspondence information until a next user issues an authentication request to the air conditioner 1 and authentication of the next user is successful.

FIG. 8 is a diagram illustrating an exemplary configuration of the correspondence information in which the device identification information is associated with the user identification information, the correspondence information being created by the owner authentication system according to the embodiment. The data management server 2 creates and store the information on the correspondence between the device identification information and the user identification information, in which correspondence information an authentication No. (number), the device identification information, and the user identification information are associated with each other.

When the authentication is unsuccessful, the data management server 2 may delete, from the correspondence information, correspondence information including the user identification information on the user terminal 3 that failed in the authentication, and correspondence information including the device identification information on the air conditioner 1 that failed in the authentication. The data management server 2 updates the correspondence information when the authentication is unsuccessful or successful.

In this manner, the owner authentication system 50 can perform authentication between the user and the air conditioner 1 without using static information (e.g., Media Access Control (MAC) address), and thus, can clearly distinguish a past owner from a current owner.

Additionally, since the owner authentication system 50 uses the air-conditioning operation data related to the air conditioner 1 as the dynamic data for performing authentication between the user and the air conditioner 1, the owner authentication system 50 can distinguish the past owner from the current owner without using additional hardware for generating the dynamic data.

Note that in the present embodiment, the description has been made taking the example where the matching verification unit 23 of the data management server 2 includes the two determination units (the operation start determination unit 24 and the variation determination unit 25). However, the matching verification unit 23 is simply required to include any one of the operation start determination unit 24 and the variation determination unit 25.

For example, the operation start determination unit 24 may determine whether the owner of the user terminal 3 is the owner of the air conditioner 1. That is, the operation start determination unit 24 may determine, on the basis of data at a start date and time, i.e., data indicating a date and time at which the operation started, whether the pieces of air-conditioning operation data match each other. Specifically, the operation start determination unit 24 may verify whether the two pieces of air-conditioning operation data match each other by comparing the operation start date and time included in the device association data with the operation start date and time included in the user association data. In this case, the matching verification unit 23 may not necessarily include the variation determination unit 25.

When the matching verification unit 23 does not include the operation start determination unit 24, the variation determination unit 25 determines whether a variation in the first air-conditioning operation data matches a variation in the second air-conditioning operation data, in any period or at any date and time. In this case, the variation determination unit 25 admits that the user terminal 3 having sent the user association data including the room temperature variation data D2y illustrated in FIG. 7 is also the owner of the air conditioner 1.

Additionally, in the present embodiment, the owner authentication system 50 includes one air conditioner 1 and one user terminal 3. However, the air conditioner 1 and the user terminal 3 connected to the data management server 2 are not limited to one each in number, and at least one of the air conditioner 1 and the user terminal 3 may be two or more in number.

Additionally, in a case where the owner authentication system 50 includes a plurality of air conditioners 1, in response to the success in the authentication of at least one user terminal 3, the data management server 2 may simultaneously authenticate the other air conditioners connected to one another through the same network communication path as that for the air conditioner 1 that succeeded in the authentication. That is, when authentication of one user terminal 3 is successful, the data management server 2 may admit that the user terminal 3 that succeeded in the authentication is the owner of all the air conditioners 1 connected to the same network communication path as that for that user terminal 3.

Furthermore, the data management server 2 according to the present embodiment uses the room temperature variation data as the dynamic data for authenticating the user terminal 3. However, the dynamic data to be used for authenticating the user terminal 3 may be data indicating a variation in outdoor air temperature, a setting temperature, change data on the setting temperature, a rotation speed of a compressor, a rotation speed of a fan, a temperature in piping of a refrigerant circuit, or data indicating a pressure in the piping of the refrigerant circuit. The compressor, the fan, and the piping of the refrigerant circuit, as referred to herein, are components of the air conditioner 1. The data indicating a variation in outdoor air temperature is data indicating a variation in outdoor air temperature of a place where an outdoor unit of the air conditioner 1 is disposed. The setting temperature is a temperature (room temperature) to be set for the air conditioner 1. The change data on the setting temperature is data indicating a change history of the setting temperature.

Additionally, the data management server 2 according to the present embodiment uses the room temperature variation data, which is one type of data, as the dynamic data to be used for authenticating the user terminal 3. However, the user terminal 3 may be authenticated using any two or more types of the above-described dynamic data. That is, the data management server 2 may employ, as the dynamic data for authenticating the user terminal 3, at least one of the room temperature variation data, the data indicating a variation in outdoor air temperature, the setting temperature, the change data on the setting temperature, the rotation speed of the compressor, the rotation speed of the fan, the temperature in the piping of the refrigerant circuit, and the data indicating the pressure in the piping of the refrigerant circuit. The data management server 2 can determine the owner with higher accuracy in a case where the data management server 2 determines the owner, using two or more types of dynamic data than the data management server 2 that performs the authentication, using one type of dynamic data.

Additionally, as described with reference to FIG. 6, when the first air-conditioning operation data 43 completely matches the second air-conditioning operation data 44, the data management server 2 according to the present embodiment authenticates the user terminal 3 as the owner of the air conditioner 1. However, the data management server 2 may perform the authentication after interpolating time data.

Additionally, the owner authentication system 50 according to the present embodiment retains, as the operation start data, the ON state or the OFF state of the power supply as illustrated in FIG. 6. However, the owner authentication system 50 may retain operation start time data or operation end time data and use, as the first air-conditioning operation data 43 and the second air-conditioning operation data 44, pieces of room temperature variation data collected in the period between the operation start time data and the operation end time data.

Furthermore, the description has been made taking the example where the owner authentication system 50 according to the present embodiment extracts the operation start data for authenticating the user terminal 3, from the operation data at the time of start of the test operation. However, the owner authentication system 50 may extract the operation start data from the operation data at the time of start of a normal cooling operation or a normal heating operation, thereby performing the authentication of the owner.

Note that in the present embodiment, the description has been made as to the example where the facility device is the air conditioner 1. However, the facility device may be a device other than the air conditioner 1. For example, the facility device may be a television, a surveillance camera, or the like.

As described above, the owner authentication system 50 does not determine whether the current owner of the air conditioner 1 is the owner of the air conditioner 1 only with the static data, but authenticates the current owner of the air conditioner 1 on the basis of the characteristics of variations in the dynamic data related to the operation of the air conditioner 1. The owner authentication system 50 authenticates the current owner of the air conditioner 1 without using additional hardware for generating dynamic data. That is, since the owner authentication system 50 is configured to use the dynamic data involved in the air conditioner 1 for authentication between the air conditioner 1 and the user terminal 3, the owner authentication system 50 can authenticate the current owner without authenticating the past owner.

Here, a description will be given of hardware configurations of the air conditioner 1, the data management server 2, and the user terminal 3. Note that since the air conditioner 1, the data management server 2, and the user terminal 3 have similar hardware configurations, the hardware configuration of the data management server 2 will be described here. The data management server 2 is implemented by processing circuitry. The processing circuitry may include a memory and a processor executing a program stored in the memory or may include dedicated hardware.

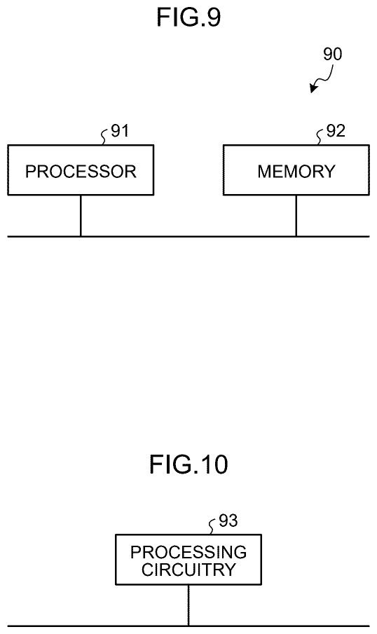

FIG. 9 is a diagram illustrating an exemplary configuration of processing circuitry in a case where a processor and a memory implement the processing circuitry included in the data management server according to the embodiment. The processing circuitry 90 illustrated in FIG. 9 includes a processor 91 and a memory 92. In the case where the processing circuitry 90 includes the processor 91 and the memory 92, each function of the processing circuitry 90 is implemented by software, firmware, or a combination of software and firmware. The software or firmware is described as a data management program and stored in the memory 92. In the processing circuitry 90, the processor 91 reads and executes the data management program stored in the memory 92 to implement each function. That is, the processing circuitry 90 includes the memory 92 for storing the data management program with which the processing of the data management server 2 is executed as a result. It can also be said that this data management program is a program for causing the data management server 2 to execute each function implemented by the processing circuitry 90. The data management program may be provided by a storage medium storing the data management program or may be provided by other means such as a communication medium.

The data management program has a module configuration including the matching verification unit 23, and these are loaded on a main storage device and generated on the main storage device.

Here, the processor 91 is, for example, a Central Processing Unit (CPU), a processing unit, an arithmetic unit, a microprocessor, a microcomputer, a Digital Signal Processor (DSP), or the like. Additionally, the memory 92 corresponds to, for example, a nonvolatile or volatile semiconductor memory such as a Random Access Memory (RAM), a Read Only Memory (ROM), a flash memory, an Erasable Programmable ROM (EPROM), or an Electrically EPROM (EEPROM, registered trademark), a magnetic disk, a flexible disk, an optical disk, a compact disk, a mini disk, a Digital Versatile Disc (DVD), or the like.

FIG. 10 is a diagram illustrating an example of processing circuitry in a case where dedicated hardware implements the processing circuitry included in the data management server according to the embodiment. The processing circuitry 93 illustrated in FIG. 10 corresponds to, for example, a single circuit, a combined circuit, a programmed processor, a parallel-programmed processor, an Application Specific Integrated Circuit (ASIC), a Field Programmable Gate Array (FPGA), or any combination thereof. Some functions of the processing circuitry 93 may be implemented by dedicated hardware, and the other functions may be implemented by software or firmware. In this manner, the processing circuitry 93 can implement the above-described functions using dedicated hardware, software, firmware, or any combination thereof.

As described above, in the embodiment, the air conditioner 1 transmits, to the data management server 2, the device association data in which the first air-conditioning operation data is associated with the device identification information, and transmits the second air-conditioning operation data to the user terminal 3. Then, the user terminal 3 transmits, to the data management server 2, the user association data in which the second air-conditioning operation data is associated with the user identification information. Additionally, the data management server 2 compares the first air-conditioning operation data included in the device association data with the second air-conditioning operation data included in the user association data to perform authentication of the air conditioner. Consequently, the data management server 2 can correctly recognize a current owner of the air conditioner 1 based on the dynamic data varying over time.

The features illustrated in connection with the above embodiment are illustrative only, and may be combined with other known techniques, or may partially be omitted or changed without going beyond the scope.

1. An owner authentication system comprising:
a facility device;
a data management server connected to the facility device; and
a user terminal connectable to the facility device and the data management server, wherein
the facility device includes:
device identification information retention circuitry to retain device identification information that is identification information on the facility device;
operation data retention circuitry to retain operation data that is dynamic data varying over time in the facility device;
first information provision circuitry to transmit, to the data management server, device association data in which first operation data in the operation data is associated with the device identification information; and
second information provision circuitry to transmit, to the user terminal, second operation data in the operation data,
the user terminal includes:
user identification information retention circuitry to retain user identification information that is identification information on the user terminal; and
authentication request circuitry to request the data management server to perform authentication of whether the user terminal is a terminal corresponding to an owner of the facility device, by transmitting, to the data management server, user association data in which the second operation data is associated with the user identification information, and
the data management server includes
matching verification circuitry to perform the authentication by comparing the first operation data included in the device association data with the second operation data included in the user association data, wherein
the matching verification circuitry determines that the user terminal is the terminal corresponding to the owner of the facility device when a variation in the first operation data in an operation start period matches a variation in the second operation data in the operation start period, the operation start period being a specific period from the start of the operation of the facility device.

2. The owner authentication system according to claim 1, wherein
the first operation data and the second operation data each include a start date and time that is a date and time at which the facility device started operating.

3. An owner authentication system comprising:
a facility device;
a data management server connected to the facility device; and
a user terminal connectable to the facility device and the data management server, wherein
the facility device includes:
device identification information retention circuitry to retain device identification information that is identification information on the facility device;
operation data retention circuitry to retain operation data that is dynamic data varying over time in the facility device;
first information provision circuitry to transmit, to the data management server, device association data in which first operation data in the operation data is associated with the device identification information; and
second information provision circuitry to transmit, to the user terminal, second operation data in the operation data,
the user terminal includes:
user identification information retention circuitry to retain user identification information that is identification information on the user terminal; and
authentication request circuitry to request the data management server to perform authentication of whether the user terminal is a terminal corresponding to an owner of the facility device, by transmitting, to the data management server, user association data in which the second operation data is associated with the user identification information, and
the data management server includes
matching verification circuitry to perform the authentication by comparing the first operation data included in the device association data with the second operation data included in the user association data, wherein
the first operation data and the second operation data each include a start date and time that is a date and time at which the facility device started operating, and
the matching verification circuitry determines that the user terminal is the terminal corresponding to the owner of the facility device when the start date and time included in the first operation data matches the start date and time included in the second operation data.

4. The owner authentication system according to claim 1, wherein
the facility device is an air conditioner, and
the first operation data and the second operation data each include at least one data among: data indicating a variation in a room temperature of a room in which an indoor unit of the air conditioner is disposed; data indicating a variation in outdoor air temperature of a place in which an outdoor unit of the air conditioner is disposed; a setting temperature to be set for the air conditioner; change data indicating a change history of the setting temperature; a rotation speed of a compressor included in the air conditioner; a rotation speed of a fan included in the air conditioner; a temperature in a piping of a refrigerant circuit included in the air conditioner; and
data indicating a pressure in the piping of the refrigerant circuit.

5. The owner authentication system according to claim 1, wherein
the data management server further includes
storage circuitry to store correspondence information in which the device identification information is associated with the user identification information when the matching verification circuitry determines that the user terminal is the terminal corresponding to the owner of the facility device.

6. The owner authentication system according to claim 5, wherein
the matching verification circuitry updates the correspondence information when the authentication is successful or unsuccessful.

7. (canceled)

8. An owner authentication system comprising:
a facility device;
a data management server connected to the facility device; and
a user terminal connectable to the facility device and the data management server, wherein
the facility device includes:
device identification information retention circuitry to retain device identification information that is identification information on the facility device;
operation data retention circuitry to retain operation data that is dynamic data varying over time in the facility device;
first information provision circuitry to transmit, to the data management server, device association data in which first operation data in the operation data is associated with the device identification information; and
second information provision circuitry to transmit, to the user terminal, second operation data in the operation data,
the user terminal includes:
user identification information retention circuitry to retain user identification information that is identification information on the user terminal; and
authentication request circuitry to request the data management server to perform authentication of whether the user terminal is a terminal corresponding to an owner of the facility device, by transmitting, to the data management server, user association data in which the second operation data is associated with the user identification information, and
the data management server includes
matching verification circuitry to perform the authentication by comparing the first operation data included in the device association data with the second operation data included in the user association data, wherein
the matching verification circuitry determines that the user terminal is the terminal corresponding to the owner of the facility device when a variation in the first operation data matches a variation in the second operation data, in any period or at any date and time.

9. The owner authentication system according to claim 3, wherein
the facility device is an air conditioner, and
the first operation data and the second operation data each include at least one data among: data indicating a variation in a room temperature of a room in which an indoor unit of the air conditioner is disposed; data indicating a variation in outdoor air temperature of a place in which an outdoor unit of the air conditioner is disposed; a setting temperature to be set for the air conditioner; change data indicating a change history of the setting temperature; a rotation speed of a compressor included in the air conditioner; a rotation speed of a fan included in the air conditioner; a temperature in a piping of a refrigerant circuit included in the air conditioner; and
data indicating a pressure in the piping of the refrigerant circuit.

10. The owner authentication system according to claim 8, wherein
the facility device is an air conditioner, and
the first operation data and the second operation data each include at least one data among: data indicating a variation in a room temperature of a room in which an indoor unit of the air conditioner is disposed; data indicating a variation in outdoor air temperature of a place in which an outdoor unit of the air conditioner is disposed; a setting temperature to be set for the air conditioner; change data indicating a change history of the setting temperature; a rotation speed of a compressor included in the air conditioner; a rotation speed of a fan included in the air conditioner; a temperature in a piping of a refrigerant circuit included in the air conditioner; and data indicating a pressure in the piping of the refrigerant circuit.

11. The owner authentication system according to claim 3, wherein
the data management server further includes storage circuitry to store correspondence information in which the device identification information is associated with the user identification information when the matching verification circuitry determines that the user terminal is the terminal corresponding to the owner of the facility device.

12. The owner authentication system according to claim 8, wherein
the data management server further includes
storage circuitry to store correspondence information in which the device identification information is associated with the user identification information when the matching verification circuitry determines that the user terminal is the terminal corresponding to the owner of the facility device.

13. The owner authentication system according to claim 11, wherein
the matching verification circuitry updates the correspondence information when the authentication is successful or unsuccessful.

14. The owner authentication system according to claim 12, wherein
the matching verification circuitry updates the correspondence information when the authentication is successful or unsuccessful.
